(19) United States
(12) Patent Application Publication
(10) Pub. No.: US 2025/0346506 A1
(43) Pub. Date: Nov. 13, 2025

(54) Membrane-Mediated Electro-Oxidation-Reduction Deep Water Treatment Device and its Operation Method Thereof

(71) Applicant: Harbin Institute of Technology, Harbin City, Heilongjiang Province (CN)

(72) Inventors: Dongwei LV, Harbin (CN); Jun MA, Harbin (CN); Zhiyu SUN, Harbin (CN); Hui ZHANG, Harbin (CN); Xinghao JIANG, Harbin (CN)

(21) Appl. No.: 18/868,746

(22) PCT Filed: Aug. 18, 2023
(86) PCT No.: PCT/CN2023/113722

§ 371 Date: Nov. 23, 2024

(30) Foreign Application Priority Data
Jan. 6, 2023 (CN) 202310018845.2

(51) Int. Cl. C02F 1/461; C02F 1/28; C02F 1/44; C02F 1/467; C02F 101/30; C02F 103/08

(52) U.S. Cl. CPC C02F 1/46109; C02F 1/283; C02F 1/444; C02F 1/4672; C02F 1/4676; C02F 2001/46142; C02F 2101/30; C02F 2103/08; C02F 2201/004; C02F 2201/46115

(57) ABSTRACT

A membrane-mediated electro-oxidation-reduction deep water treatment device and an operation method thereof, is related to the technical fields of electrochemistry, membrane separation and water treatment. The present invention provides a membrane-mediated electro-oxidation-reduction deep water treatment device of which the anode conductive membrane and the cathode conductive membrane are respectively connected to the positive and negative electrodes of an external power supply through conductive connectors. The fluid to be treated vertically penetrates through the conductive membranes (the anode conductive membrane and the cathode conductive membrane). When current passes through, the anode conductive membrane and the cathode conductive membrane produce a synergistic effect of electrochemical oxidation and reduction. At the same time, the three-dimensional carbon particles electrode becomes a bipolar particles electrode due to the induced electric field, so that the conductive membrane and the three-dimensional carbon particles electrode generate active species with strong redox in situ, expanding the reaction area, and being able to quickly degrade refractory organic pollutants in water. The present invention can obtain a membrane-mediated electro-oxidation-reduction deep water treatment device and an operation method thereof.

### FIELD OF INVENTION

The present invention relates to the technical fields of electrochemistry, membrane separation and water treatment, and more particularly to a membrane-mediated electro-oxidation-reduction deep water treatment device and its operation method thereof.

### DESCRIPTION OF RELATED ARTS

Due to the widespread use and stubbornness of refractory organic pollutants, they continue to accumulate in water bodies and aquatic organisms, and have obvious special toxicity to the immune system, posing a threat to the aquatic ecological environment and water safety. At present, the removal technologies of refractory organic pollutants in water bodies mainly include physical and chemical methods, wherein adsorption and membrane filtration are the most commonly used physical methods, and chemical methods are mainly based on oxidation-reduction. Nanofiltration or reverse osmosis membranes can separate refractory organic pollutants in water through size screening and electrostatic repulsion, but their high-pressure operation process leads to energy consumption remain at a high level. At the same time, membrane fouling causes flux reduction, increased energy consumption and faster membrane replacement frequency, which lead to increased disposal burden for subsequent concentrated waste stream treatment, making membrane separation face great challenges in the process of removing refractory organic pollutants. Also, single oxidation or reduction methods for degrading such pollutants have low efficiency, many by-products, and high risk of secondary pollution.

Conductive membrane combines the advantages of electrochemistry and membrane filtration to achieve rapid, sustainable and more thorough degradation and removal of refractory organic pollutants in water, and is an emerging water purification technology. The conductive membrane can make full use of the membrane pore space and “through-flow” electrochemical reaction, thereby generating strongly redox active species in situ, strengthening the confinement effect and electron transfer within the membrane, and improving the pollutant removal efficiency. In addition, the three-dimensional particles electrode can form an induced electric field between the anode and the cathode, which not only enhances the enrichment of organic matter, but also expands the contact area of the electrochemical reaction, further solving the problems of difficult adsorption and low degradation efficiency. As of now, the conductive membranes mentioned in the existing literature are only combined with a single electrode, that is, the half-cell reaction is inside the membrane, so that the corresponding electrode reaction cannot be fully utilized, thereby reducing the efficiency of electrical energy utilization. Therefore, the respective advantages of physical and chemical treatment methods are coupled to design and construct a membrane-mediated electro-oxidation-reduction deep treatment system to achieve efficient removal of difficult-to-degrade organic pollutants and self-cleaning of membrane pollution. Conductive membranes and three-dimensional particles electrode are used to form electric fields and induced electric fields, improve current efficiency and pollutant removal efficiency, reduce energy consumption and enhance adjustable performance, which is of great significance for exploring the removal of refractory organic pollutants.

### SUMMARY OF THE PRESENT INVENTION

An object of the present invention is to solve the above technical problems, and provide a membrane-mediated electro-oxidation-reduction deep water treatment device and its operation method thereof.

A membrane-mediated electro-oxidation-reduction deep water treatment device comprises: a feeding device 1, a nitrogen storage device 2, a membrane-mediated oxidation-reduction assembly 4 and a pump 6; the membrane-mediated oxidation-reduction assembly 4 is composed of a feeding chamber 4-1, a reaction chamber 4-2, a permeation chamber 4-3, an anode conductive membrane 4-4, a cathode conductive membrane 4-5, a three-dimensional carbon particles electrode 4-6, six annular sealing rubber rings 4-7, two partition panels 4-8, two conductive connectors 4-11 and an external power supply 5.

The feeding chamber 4-1 is provided with a membrane assembly water inlet 4-9 and a reflux fluid outlet 4-12 respectively; an outer periphery between the feeding chamber 4-1 and the anode conductive membrane 4-4 is sealed and connected into position through one annular sealing rubber ring 4-7, one partition panel 4-8 is provided between the anode conductive membrane 4-4 and the reaction chamber 4-2, and outer peripheries between the anode conductive membrane 4-4 and the partition panel 4-8 and between the partition panel 4-8 and the reaction chamber 4-2 are sealed and connected into position through one annular sealing rubber ring 4-7 respectively; a partition panel 4-8 is provided between the reaction chamber 4-2 and the cathode conductive membrane 4-5, and outer peripheries between the reaction chamber 4-2 and the partition panel 4-8 and between the partition panel 4-8 and the cathode conductive membrane 4-5 are sealed and connected into position through one annular sealing rubber ring 4-7 respectively; an outer periphery between the cathode conductive membrane 4-5 and the permeation chamber 4-3 is sealed and connected into position through one annular sealing rubber ring 4-7, and a membrane assembly water outlet 4-10 is provided on one side of the permeation chamber 4-3; the reaction chamber 4-2 is filled with a three-dimensional carbon particles electrode 4-6.

A water outlet of the feeding device 1 is connected to a water inlet of the nitrogen storage device through a connecting pipe, a water outlet of the nitrogen storage device is connected to the membrane assembly water inlet 4-9 of the membrane-mediated electro-oxidation-reduction assembly 4 through a connecting pipe, and a valve 3 is provided on the connecting pipe; the reflux fluid water outlet 4-12 of the membrane-mediated electro-oxidation-reduction assembly 4 is connected to an water inlet of the feeding device 1 through a connecting pipe, and a pump 6 is provided on the connecting pipe.

One end of one of the conductive connectors 4-11 is sandwiched between the feeding chamber 4-1 and the anode conductive membrane 4-4, and another end of the conductive connector 4-11 is electrically connected to a positive electrode of the external power supply 5; one end of another one of the conductive connectors 4-11 is sandwiched between the cathode conductive membrane 4-5 and the permeation chamber 4-3, and another end of the conductive connector 4-11 is electrically connected to the negative electrode of the external power supply 5.

An operation method of the membrane-mediated electro-oxidation-reduction deep water treatment device is carried out according to the following steps:

Connecting the anode conductive membrane 4-4 to the positive electrode of the external power supply 5 through the conductive connector 4-11, connecting the cathode conductive membrane 4-5 to the negative electrode of the external power supply 5 through the conductive connector 4-11; pressurizing a fluid for treatment received inside the feeding device 1 by a nitrogen cylinder and then injecting the fluid for treatment into the feeding chamber 4-1 through the membrane assembly water inlet 4-9, starting a peristaltic pump so that the fluid for treatment passes through the reflux fluid outlet 4-12 through the connecting pipe to flow back to the feeding device 1; the fluid for treatment passing through the anode conductive membrane 4-4 for electro-oxidation filtration and entering the reaction chamber 4-2, and then passing through the three-dimensional carbon particles electrode 4-6 for adsorption and electrocatalysis; then, carrying out the electro-reduction filtration through the cathode conductive membrane 4-5, and the treated permeate flowing out through the membrane assembly outlet 4-10, thereby the degradation of organic pollutants in the fluid for treatment is completed.

The advantages of the present invention are as follows:

(1) The present invention provides a membrane-mediated electro-oxidation-reduction deep water treatment device. The anode conductive membrane and the cathode conductive membrane are respectively connected to the positive and negative electrodes of an external power supply through conductive connectors. The fluid for treatment vertically penetrates through the conductive membranes (the anode conductive membrane and the cathode conductive membrane). When current passes through, the anode conductive membrane and the cathode conductive membrane produce a synergistic effect of electrochemical oxidation and reduction. At the same time, the three-dimensional carbon particles electrode becomes a bipolar particles electrode due to the induced electric field, so that the conductive membrane and the three-dimensional carbon particles electrode generate active species with strong redox in situ, expanding the reaction area, and being able to quickly degrade refractory organic pollutants in water.

(2) The present invention organically combines the full-cell reaction, membrane confinement effect and induced micro-electric field effect. The entire reaction process does not require the addition of oxidizing or reducing agents, which effectively reduces the risk of secondary contamination of pharmaceuticals. At the same time, the electrochemical oxidation and reduction process can completely destroy the molecular structure of organic matters and avoid the generation of waste streams of harmful byproducts. In addition, the electrochemical controllability is strong, the operation is stable, and the conductive membrane can be self-cleaned. The system has a high reuse rate and solves the problems of membrane pollution and degradation stability. The present invention has a simple process, small footprint, and convenient operation and management.

The present invention effectively combines electrochemistry with membrane filtration technology, which can give full play to the functions and characteristics of electrochemical anionic and anodic bipolar reactions, so that electrochemical oxidation and reduction reactions act synergistically on the surface of the conductive filter membrane, thus solving the problem of membrane pollution while achieving rapid removal of refractory organic pollutants.

The present invention can obtain a membrane-mediated electro-oxidation-reduction deep water treatment device and an operation method thereof.

### BRIEF DESCRIPTION OF THE DRAWINGS

FIG. 1 is a schematic diagram showing the structure of a membrane-mediated electro-oxidation-reduction deep water treatment device in Exemplary embodiment 1, 1 refers to a feeding device, 2 refers to a nitrogen storage device, 3 refers to a valve, 4 refers to a membrane-mediated electro-oxidation-reduction assembly, 4-1 refers to a feeding chamber, 4-2 refers to a reaction chamber, 4-3 refers to a permeation chamber, 4-4 refers to an anode conductive membrane, 4-5 refers to a cathode conductive membrane, 4-6 refers to a three-dimensional carbon particles electrode, 4-7 refers to an annular sealing rubber ring, 4-8 refers to a partition panel, 4-9 refers to a membrane assembly water inlet, 4-10 refers to a membrane assembly water outlet, 4-11 refers to a conductive connector, 4-12 refers to a reflux fluid outlet, 5 refers to an external power supply, and 6 refers to a pump.

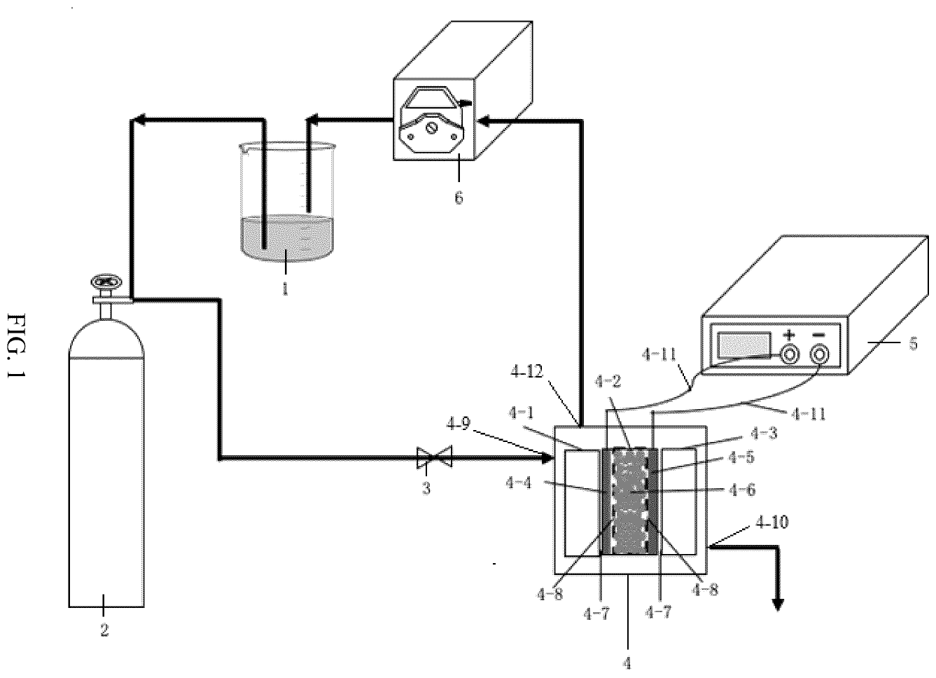

FIG. 2 is a three-dimensional exploded view of the membrane-mediated oxidation-reduction assembly in Exemplary embodiment 1, 4-1 refers to the feeding chamber, 4-2 refers to the reaction chamber, 4-3 refers to the permeation chamber, 4-4 refers to the anode conductive membrane, 4-5 refers to the cathode conductive membrane, 4-7 refers to the annular sealing rubber ring, 4-8 refers to the partition panel, 4-9 refers to the membrane assembly water inlet, 4-10 refers to the membrane assembly water outlet, 4-12 refers to the reflux fluid water outlet.

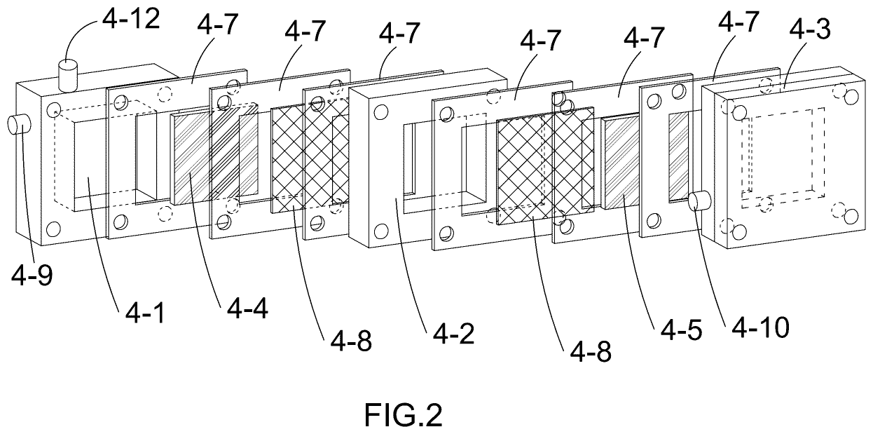

### DETAILED DESCRIPTION OF THE PREFERRED EMBODIMENT

Preferred Embodiment 1: According to this embodiment, a membrane-mediated electro-oxidation-reduction deep water treatment device comprises: a feeding device 1, a nitrogen storage device 2, a membrane-mediated oxidation-reduction assembly 4 and a pump 6; the membrane-mediated oxidation-reduction assembly 4 is composed of a feeding chamber 4-1, a reaction chamber 4-2, a permeation chamber 4-3, an anode conductive membrane 4-4, a cathode conductive membrane 4-5, a three-dimensional carbon particles electrode 4-6, six annular sealing rubber rings 4-7, two partition panels 4-8, two conductive connectors 4-11 and an external power supply 5.

The feeding chamber 4-1 is provided with a membrane assembly water inlet 4-9 and a reflux fluid outlet 4-12 respectively; an outer periphery between the feeding chamber 4-1 and the anode conductive membrane 4-4 is sealed and connected into position through one annular sealing rubber ring 4-7, one partition panel 4-8 is provided between the anode conductive membrane 4-4 and the reaction chamber 4-2, and outer peripheries between the anode conductive membrane 4-4 and the partition panel 4-8 and between the partition panel 4-8 and the reaction chamber 4-2 are sealed and connected into position through one annular sealing rubber ring 4-7 respectively; a partition panel 4-8 is provided between the reaction chamber 4-2 and the cathode conductive membrane 4-5, and outer peripheries between the reaction chamber 4-2 and the partition panel 4-8 and between the partition panel 4-8 and the cathode conductive membrane 4-5 are sealed and connected into position through one annular sealing rubber ring 4-7 respectively; an outer periphery between the cathode conductive membrane 4-5 and the permeation chamber 4-3 is sealed and connected into position through one annular sealing rubber ring 4-7, and a membrane assembly water outlet 4-10 is provided on one side of the permeation chamber 4-3; the reaction chamber 4-2 is filled with a three-dimensional carbon particles electrode 4-6.

A water outlet of the feeding device 1 is connected to a water inlet of the nitrogen storage device through a connecting pipe, a water outlet of the nitrogen storage device is connected to the membrane assembly water inlet 4-9 of the membrane-mediated electro-oxidation-reduction assembly 4 through a connecting pipe, and a valve 3 is provided on the connecting pipe; the reflux fluid water outlet 4-12 of the membrane-mediated electro-oxidation-reduction assembly 4 is connected to an water inlet of the feeding device 1 through a connecting pipe, and a pump 6 is provided on the connecting pipe.

One end of one of the conductive connectors 4-11 is sandwiched between the feeding chamber 4-1 and the anode conductive membrane 4-4, and another end of the conductive connector 4-11 is electrically connected to a positive electrode of the external power supply 5; one end of another one of the conductive connectors 4-11 is sandwiched between the cathode conductive membrane 4-5 and the permeation chamber 4-3, and another end of the conductive connector 4-11 is electrically connected to the negative electrode of the external power supply 5.

The conductive connector 4-11 is any commercially available one, and is sandwiched between the feeding chamber 4-1 and the anode conductive membrane 4-4 and between the cathode conductive membrane 4-5 and the permeation chamber 4-3, and is pressed tightly by the annular sealing rubber rings 4-7 on both sides.

Preferred Embodiment 2: The difference between this embodiment and Preferred Embodiment 1 is that: the nitrogen storage device 2 is a nitrogen cylinder.

The other steps are the same as those in the Preferred Embodiment 1.

Preferred Embodiment 3: The difference between this embodiment and Preferred Embodiment 1 or 2 is that: the pump 6 is a peristaltic pump.

The other steps are the same as those in the Preferred Embodiment 1 or 2.

Preferred Embodiment 4: The difference between this embodiment and any one of the Preferred Embodiments 1-3 is that: the anode conductive membrane 4-4 is a microfiltration membrane or an ultrafiltration membrane with a thickness of 0.1˜0.3 mm. The preparation method is as follows: a casting solution prepared with a conductive material is applied to a glass plate by scraping, a flat dense film is obtained by a phase inversion method, and then a high-temperature calcination is carried out under a nitrogen atmosphere to obtain the membrane. The conductive material is one or more of a metal, a metal oxide and a conductive carbon material.

The other steps are the same as those in the Preferred Embodiment 1-3.

Preferred Embodiment 5: The difference between this embodiment and any one of the Preferred Embodiments 1-4 is that: the cathode conductive membrane 4-5 is a microfiltration membrane or an ultrafiltration membrane with a thickness of 0.1˜0.3 mm. The preparation method is as follows: a casting solution prepared with a conductive material is applied to a glass plate by scraping, a flat dense film is obtained by a phase inversion method, and then a high-temperature calcination is carried out under a nitrogen atmosphere to obtain the membrane. The conductive material is one or more of a metal, a metal oxide and a conductive carbon material.

The other steps are the same as those in the Preferred Embodiment 1-4.

Preferred Embodiment 6: The difference between this embodiment and any one of the Preferred Embodiments 1-5 is that: the three-dimensional carbon particles electrode 4-6 are made by loading porous electrocatalytic particles of metal oxides, carbon nanotubes, carbon nanowires, carbon nanospheres or graphene on a carbon substrate, wherein the carbon substrate is processed and formed by granular carbon, columnar carbon or powdered carbon, and the metal oxide is one or more of Ti, Mn, Ce, Ni, Co, Cu, Zn, Fe, Sn, Sb, Pb, Ir and Ru and their oxides.

The other steps are the same as those in the Preferred Embodiment 1-5.

Preferred Embodiment 7: The difference between this embodiment and any one of the Preferred Embodiments 1-6 is that: the annular sealing rubber ring 4-7 is made of silica gel and has a thickness of 1-2 mm; the partition panel 4-8 is made of polypropylene or polytetrafluoroethylene of non-conductive polymer materials; the partition panel 4-8 has uniformly distributed micropores, and the micropore has a pore size smaller than the maximum diameter of the porous electrocatalytic particles.

The annular sealing rubber rings 4-7 are arranged in pairs at the outer peripheries of the anode conductive membrane 4-4, the reaction chamber 4-2 and the cathode conductive membrane 4-5 to prevent the fluid for treatment in the feeding chamber 4-1, the reaction chamber 4-2 and the permeation chamber 4-3 from leaking out from the outer peripheries of the anode conductive membrane 4-4 and the cathode conductive membrane 4-5.

Due to the effect of the partition panels 4-8, the three-dimensional carbon particles electrode 4-6 is not directly connected to the anode conductive membrane 4-4 or the cathode conductive membrane 4-5, and becomes a bipolar particles electrode through the induced electric field generated between the anode or the cathode, generating anode and cathode corresponding to the electrodes at both ends of the particle to oxidize and reduce refractory organic pollutants, thereby achieving chain breaking and decarboxylation of organic matters, thereby improving degradation efficiency.

The other steps are the same as those in the Preferred Embodiment 1-6.

Preferred Embodiment 8: The difference between this embodiment and any one of the Preferred Embodiments 1-7 is that: The voltage applied by the external power supply 5 to the anode conductive membrane 4-4 and the cathode conductive membrane 4-5 is 1-5V.

The other steps are the same as those in the Preferred Embodiment 1-7.

Preferred Embodiment 9: According to this embodiment, a method of operating a membrane-mediated electro-oxidation-reduction deep water treatment device is carried out according to the following steps:

Connect the anode conductive membrane 4-4 to the positive electrode of the external power supply 5 through the conductive connector 4-11, connect the cathode conductive membrane 4-5 to the negative electrode of the external power supply 5 through the conductive connector 4-11; pressurize a fluid for treatment received inside the feeding device 1 by a nitrogen cylinder and then inject the fluid for treatment into the feeding chamber 4-1 through the membrane assembly water inlet 4-9, start a peristaltic pump so that the fluid for treatment passes through the reflux fluid outlet 4-12 through the connecting pipe to flow back to the feeding device 1; the fluid for treatment passes through the anode conductive membrane 4-4 for electro-oxidation filtration and enters the reaction chamber 4-2, and then passes through the three-dimensional carbon particles electrode 4-6 for adsorption and electrocatalysis; then, carry out the electro-reduction filtration through the cathode conductive membrane 4-5, and the treated permeate flowing out through the membrane assembly outlet 4-10, thereby the degradation of organic pollutants in the fluid for treatment is completed.

Preferred Embodiment 10: The difference between this embodiment and Preferred Embodiment 9 is that: the organic pollutants include aldrin, chlordane, dieldrin, endrin, heptachlor, hexabromobiphenyl, mirex, toxaphene, polychlorinated biphenyls, DDT, polychlorinated dibenzo-p-dioxins, polychlorinated dibenzofurans, alpha-hexachlorocyclohexane, beta-hexachlorocyclohexane, lindane, chlordecone, pentachlorobenzene, pentachlorophenol and its salts and esters, hexachlorobutadiene, polychlorinated naphthalene, short-chain chlorinated paraffins, dicofol, technical-grade endosulfan and its isomers, hexabromobiphenyl, hexabromocyclododecane, tetrabromodiphenyl ether, pentabromodiphenyl ether, hexabromodiphenyl ether, heptabromodiphenyl ether, decabromodiphenyl ether and perfluorooctanoic acid and its salts.

The other steps are the same as those in the Preferred Embodiment 9.

The following exemplary embodiments are used to verify the beneficial effects of the present invention:

Exemplary Embodiment 1: A membrane-mediated electro-oxidation-reduction deep water treatment device comprises: a feeding device 1, a nitrogen storage device 2, a membrane-mediated oxidation-reduction assembly 4 and a pump 6; the membrane-mediated oxidation-reduction assembly 4 is composed of a feeding chamber 4-1, a reaction chamber 4-2, a permeation chamber 4-3, an anode conductive membrane 4-4, a cathode conductive membrane 4-5, a three-dimensional carbon particles electrode 4-6, six annular sealing rubber rings 4-7, two partition panels 4-8, two conductive connectors 4-11 and an external power supply 5.

The feeding chamber 4-1 is provided with a membrane assembly water inlet 4-9 and a reflux fluid outlet 4-12 respectively; an outer periphery between the feeding chamber 4-1 and the anode conductive membrane 4-4 is sealed and connected into position through one annular sealing rubber ring 4-7, one partition panel 4-8 is provided between the anode conductive membrane 4-4 and the reaction chamber 4-2, and outer peripheries between the anode conductive membrane 4-4 and the partition panel 4-8 and between the partition panel 4-8 and the reaction chamber 4-2 are sealed and connected into position through one annular sealing rubber ring 4-7 respectively; a partition panel 4-8 is provided between the reaction chamber 4-2 and the cathode conductive membrane 4-5, and outer peripheries between the reaction chamber 4-2 and the partition panel 4-8 and between the partition panel 4-8 and the cathode conductive membrane 4-5 are sealed and connected into position through one annular sealing rubber ring 4-7 respectively; an outer periphery between the cathode conductive membrane 4-5 and the permeation chamber 4-3 is sealed and connected into position through one annular sealing rubber ring 4-7, and a membrane assembly water outlet 4-10 is provided on one side of the permeation chamber 4-3; the reaction chamber 4-2 is filled with a three-dimensional carbon particles electrode 4-6.

A water outlet of the feeding device 1 is connected to a water inlet of the nitrogen storage device through a connecting pipe, a water outlet of the nitrogen storage device is connected to the membrane assembly water inlet 4-9 of the membrane-mediated electro-oxidation-reduction assembly 4 through a connecting pipe, and a valve 3 is provided on the connecting pipe; the reflux fluid water outlet 4-12 of the membrane-mediated electro-oxidation-reduction assembly 4 is connected to an water inlet of the feeding device 1 through a connecting pipe, and a pump 6 is provided on the connecting pipe.

One end of one of the conductive connectors 4-11 is sandwiched between the feeding chamber 4-1 and the anode conductive membrane 4-4, and another end of the conductive connector 4-11 is electrically connected to a positive electrode of the external power supply 5; one end of another one of the conductive connectors 4-11 is sandwiched between the cathode conductive membrane 4-5 and the permeation chamber 4-3, and another end of the conductive connector 4-11 is electrically connected to the negative electrode of the external power supply 5.

The nitrogen storage device 2 is a nitrogen cylinder. the pump 6 is a peristaltic pump.

The anode conductive membrane 4-4 is a microfiltration membrane or an ultrafiltration membrane with a thickness of 0.1˜0.3 mm. The preparation method is as follows: a casting solution prepared with a conductive material is applied to a glass plate by scraping, a flat dense film is obtained by a phase inversion method, and then a high-temperature calcination is carried out under a nitrogen atmosphere to obtain the membrane.

The cathode conductive membrane 4-5 is a microfiltration membrane or an ultrafiltration membrane with a thickness of 0.1˜0.3 mm. The preparation method is as follows: a casting solution prepared with a conductive material is applied to a glass plate by scraping, a flat dense film is obtained by a phase inversion method, and then a high-temperature calcination is carried out under a nitrogen atmosphere to obtain the membrane.

The three-dimensional carbon particles electrode 4-6 is made by loading porous electrocatalytic particles of metal oxides, carbon nanotubes, carbon nanowires, carbon nanospheres or graphene on a carbon substrate; metal oxides, carbon nanotubes, carbon nanowires, carbon nanospheres or graphene can be directly obtained through commercial purchasing channels. The carbon substrate is processed and formed by granular carbon, columnar carbon or powdered carbon, and the metal oxide is one or more of Ti, Mn, Ce, Ni, Co, Cu, Zn, Fe, Sn, Sb, Pb, Ir and Ru and their oxides.

The annular sealing rubber ring 4-7 is made of silica gel and has a thickness of 1-2 mm. The partition panel 4-8 is made of polypropylene or polytetrafluoroethylene, and can be obtained by purchasing commercial materials and then processing them into shapes. The partition panel 4-8 has uniformly distributed micropores, and the micropore has a pore size smaller than the maximum diameter of the porous electrocatalytic particle.

The reflux fluid outlet 4-12 is used as a backup to prevent the system from failing to treat pollutants as expected due to aging or damage.

The voltage applied by the external power supply 5 to the anode conductive membrane 4-4 and the cathode conductive membrane 4-5 is 1˜5V.

Exemplary Embodiment 2: A method of operating a membrane-mediated electro-oxidation-reduction deep water treatment device is carried out according to the following steps:

Connecting the anode conductive membrane 4-4 to the positive electrode of the external power supply 5 through the conductive connector 4-11, connecting the cathode conductive membrane 4-5 to the negative electrode of the external power supply 5 through the conductive connector 4-11; pressurizing a fluid for treatment received inside the feeding device 1 by a nitrogen cylinder and then injecting the fluid for treatment into the feeding chamber 4-1 through the membrane assembly water inlet 4-9, starting a peristaltic pump so that the fluid for treatment passes through the reflux fluid outlet 4-12 through the connecting pipe to flow back to the feeding device 1; the fluid for treatment passing through the anode conductive membrane 4-4 for electro-oxidation filtration and entering the reaction chamber 4-2, and then passing through the three-dimensional carbon particles electrode 4-6 for adsorption and electrocatalysis; then, carrying out the electro-reduction filtration through the cathode conductive membrane 4-5, and the treated permeate flowing out through the membrane assembly outlet 4-10, thereby the degradation of organic pollutants in the fluid for treatment is completed.

According to this embodiment, the feeding chamber 4-1, the reaction chamber 4-2 and the permeation chamber 4-3 are all formed by processing commercially purchased organic glass or perfluoroethylene, and the linear distance between the anode conductive membrane 4-4 and the cathode conductive membrane 4-5 is 10˜25 mm.

The anode conductive membrane 4-4 and the cathode conductive membrane 4-5 are microfiltration membranes or ultrafiltration membranes. The pore size of the microfiltration membrane is 0.1˜10 μm, and the molecular weight cutoff measured by polyethylene glycol (PEG) with a known molecular weight is greater than 300000 Daltons; the pore size of the ultrafiltration membrane is 0.005˜0.1 μm, and the molecular weight cutoff measured by polyethylene glycol (PEG) with a known molecular weight is 1000˜300000 Daltons.

The organic pollutants include aldrin, chlordane, dieldrin, endrin, heptachlor, hexabromobiphenyl, mirex, toxaphene, polychlorinated biphenyls, DDT, polychlorinated dibenzo-p-dioxins, polychlorinated dibenzofurans, alpha-hexachlorocyclohexane, beta-hexachlorocyclohexane, lindane, chlordecone, pentachlorobenzene, pentachlorophenol and its salts and esters, hexachlorobutadiene, polychlorinated naphthalene, short-chain chlorinated paraffins, dicofol, technical-grade endosulfan and its isomers, hexabromobiphenyl, hexabromocyclododecane, tetrabromodiphenyl ether, pentabromodiphenyl ether, hexabromodiphenyl ether, heptabromodiphenyl ether, decabromodiphenyl ether and perfluorooctanoic acid and its salts.

This embodiment provides a membrane-mediated electro-oxidation-reduction deep water treatment technology, and designs a component guided by the order of anode membrane-three-dimensional carbon particle electrode-cathode membrane, which organically combines the full-cell reaction, membrane confinement effect and induced micro-electric field effect. Wherein the anode conductive membrane 4-4 and the cathode conductive membrane 4-5 are respectively connected to the positive and negative electrodes of the external power supply 5 through the conductive connectors 4-11. When current flows through, the fluid for treatment penetrates in a direction perpendicular to the conductive membrane, making full use of the full-cell reaction to generate species with strong redox activity, achieving the synergistic effect of electro-oxidation and electro-reduction, enhancing direct electron transfer and confinement effects, greatly reducing the chemical stability of difficult-to-degrade organic pollutants, and thus achieving rapid degradation.

1. A membrane-mediated electro-oxidation-reduction deep water treatment device, characterized in that, said membrane-mediated electro-oxidation-reduction deep water treatment device comprises: a feeding device (1), a nitrogen storage device (2), a membrane-mediated oxidation-reduction assembly (4) and a pump (6); said membrane-mediated oxidation-reduction assembly (4) is composed of a feeding chamber (4-1), a reaction chamber (4-2), a permeation chamber (4-3), an anode conductive membrane (4-4), a cathode conductive membrane (4-5), a three-dimensional carbon particles electrode (4-6), six annular sealing rubber rings (4-7), two partition panels (4-8), two conductive connectors (4-11) and an external power supply (5);
said feeding chamber (4-1) is provided with a membrane assembly water inlet (4-9) and a reflux fluid outlet (4-12) respectively; an outer periphery between the feeding chamber (4-1) and the anode conductive membrane (4-4) is sealed and connected into position through one annular sealing rubber ring (4-7), one partition panel (4-8) is provided between the anode conductive membrane (4-4) and the reaction chamber (4-2), and outer peripheries between the anode conductive membrane (4-4) and the partition panel (4-8) and between the partition panel (4-8) and the reaction chamber (4-2) are sealed and connected into position through one annular sealing rubber ring (4-7) respectively; a partition panel (4-8) is provided between the reaction chamber (4-2) and the cathode conductive membrane (4-5), and outer peripheries between the reaction chamber (4-2) and the partition panel (4-8) and between the partition panel (4-8) and the cathode conductive membrane (4-5) are sealed and connected into position through one annular sealing rubber ring (4-7) respectively; an outer periphery between the cathode conductive membrane (4-5) and the permeation chamber (4-3) is sealed and connected into position through one annular sealing rubber ring (4-7), and a membrane assembly water outlet (4-10) is provided on one side of the permeation chamber (4-3); the reaction chamber (4-2) is filled with a three-dimensional carbon particles electrode (4-6);
a water outlet of the feeding device (1) is connected to a water inlet of the nitrogen storage device through a connecting pipe, a water outlet of the nitrogen storage device is connected to the membrane assembly water inlet (4-9) of the membrane-mediated electro-oxidation-reduction assembly (4) through a connecting pipe, and a valve (3) is provided on the connecting pipe; the reflux fluid water outlet (4-12) of the membrane-mediated electro-oxidation-reduction assembly (4) is connected to an water inlet of the feeding device (1) through a connecting pipe, and a pump (6) is provided on the connecting pipe;
one end of one said conductive connectors (4-11) is sandwiched between the feeding chamber (4-1) and the anode conductive membrane (4-4), and another end of said conductive connector (4-11) is electrically connected to a positive electrode of the external power supply (5); one end of another said conductive connectors (4-11) is sandwiched between the cathode conductive membrane (4-5) and the permeation chamber (4-3), and another end of said another conductive connector (4-11) is electrically connected to the negative electrode of the external power supply (5).

2. The membrane-mediated electro-oxidation-reduction deep water treatment device according to claim 1, characterized in that, the nitrogen storage device (2) is a nitrogen cylinder.

3. The membrane-mediated electro-oxidation-reduction deep water treatment device according to claim 1, characterized in that, the pump (6) is a peristaltic pump.

4. The membrane-mediated electro-oxidation-reduction deep water treatment device according to claim 1, characterized in that, the anode conductive membrane (4-4) is a microfiltration membrane or an ultrafiltration membrane having a thickness of 0.1˜0.3 mm, and is prepared by the following method: applying a casting solution prepared with a conductive material to a glass plate by scraping, obtaining a flat dense film by a phase-inversion method, and then carrying out a high-temperature calcination under a nitrogen atmosphere to obtain the membrane; the conductive material is one or more of a metal, a metal oxide and a conductive carbon material.

5. The membrane-mediated electro-oxidation-reduction deep water treatment device according to claim 1, characterized in that, the cathode conductive membrane (4-5) is a microfiltration membrane or an ultrafiltration membrane having a thickness of 0.1˜0.3 mm, and is prepared by the following method: applying a casting solution prepared with a conductive material to a glass plate by scraping, obtaining a flat dense film by a phase-inversion method, and then carrying out a high-temperature calcination under a nitrogen atmosphere to obtain the membrane; the conductive material is one or more of a metal, a metal oxide and a conductive carbon material.

6. The membrane-mediated electro-oxidation-reduction deep water treatment device according to claim 1, characterized in that, the three-dimensional carbon particles electrode (4-6) is made by loading porous electrocatalytic particles of metal oxides, carbon nanotubes, carbon nanowires, carbon nanospheres or graphenes on a carbon substrate, wherein the carbon substrate is processed and formed by granular carbon, columnar carbon or powdered carbon, and the metal oxides is one or more of Ti, Mn, Ce, Ni, Co, Cu, Zn, Fe, Sn, Sb, Pb, Ir and Ru and their oxides.

7. The membrane-mediated electro-oxidation-reduction deep water treatment device according to claim 1, characterized in that, the annular sealing rubber ring (4-7) is made of silica gel and have a thickness of 1˜2 mm; the partition panel (4-8) is made of polypropylene or polytetrafluoroethylene, and the partition panel (4-8) has uniformly distributed micropores thereon, and the micropore has a pore size smaller than a maximum diameter of the porous electrocatalytic particle.

8. The membrane-mediated electro-oxidation-reduction deep water treatment device according to claim 1, characterized in that, a voltage applied by the external power supply (5) to the anode conductive membrane (4-4) and the cathode conductive membrane (4-5) is 1˜5V.

9. An operation method of said membrane-mediated electro-oxidation-reduction deep water treatment device according to claim 1, characterized in that,
connecting the anode conductive membrane (4-4) to the positive electrode of the external power supply (5) through the conductive connector (4-11), connecting the cathode conductive membrane (4-5) to the negative electrode of the external power supply (5) through the conductive connector (4-11); pressurizing a fluid for treatment received inside the feeding device (1) by a nitrogen cylinder and then injecting the fluid for treatment into the feeding chamber (4-1) through the membrane assembly water inlet (4-9), starting a peristaltic pump so that the fluid for treatment passes through the reflux fluid outlet (4-12) through the connecting pipe to flow back to the feeding device (1); the fluid for treatment passing through the anode conductive membrane (4-4) for electro-oxidation filtration and entering the reaction chamber (4-2), and then passing through the three-dimensional carbon particles electrode (4-6) for adsorption and electrocatalysis; then, carrying out the electro-reduction filtration through the cathode conductive membrane (4-5), and the treated permeate flowing out through the membrane assembly outlet (4-10), thereby degradation of organic pollutants in the fluid for treatment is completed.

10. The membrane-mediated electro-oxidation-reduction deep water treatment device according to claim 9, characterized in that, the organic pollutants comprises aldrin, chlordane, dieldrin, endrin, heptachlor, hexabromobiphenyl, mirex, toxaphene, polychlorinated biphenyls, DDT, polychlorinated dibenzo-p-dioxins, polychlorinated dibenzofurans, alpha-hexachlorocyclohexane, beta-hexachlorocyclohexane, lindane, chlordecone, pentachlorobenzene, pentachlorophenol and its salts and esters, hexachlorobutadiene, polychlorinated naphthalene, short-chain chlorinated paraffins, dicofol, technical-grade endosulfan and its isomers, hexabromocyclododecane, tetrabromodiphenyl ether, pentabromodiphenyl ether, hexabromodiphenyl ether, heptabromodiphenyl ether, decabromodiphenyl ether and perfluorooctanoic acid and its salts.

11. The membrane-mediated electro-oxidation-reduction deep water treatment device according to claim 6, characterized in that, the annular sealing rubber ring (4-7) is made of silica gel and have a thickness of 1˜2 mm; the partition panel (4-8) is made of polypropylene or polytetrafluoroethylene, and the partition panel (4-8) has uniformly distributed micropores thereon, and the micropore has a pore size smaller than a maximum diameter of the porous electrocatalytic particle.

12. The membrane-mediated electro-oxidation-reduction deep water treatment device according to claim 4, characterized in that, a voltage applied by the external power supply (5) to the anode conductive membrane (4-4) and the cathode conductive membrane (4-5) is 1˜5V.

13. The membrane-mediated electro-oxidation-reduction deep water treatment device according to claim 5, characterized in that, a voltage applied by the external power supply (5) to the anode conductive membrane (4-4) and the cathode conductive membrane (4-5) is 1˜5V.

14. An operation method of said membrane-mediated electro-oxidation-reduction deep water treatment device according to claim 2, characterized in that, connecting the anode conductive membrane (4-4) to the positive electrode of the external power supply (5) through the conductive connector (4-11), connecting the cathode conductive membrane (4-5) to the negative electrode of the external power supply (5) through the conductive connector (4-11); pressurizing a fluid for treatment received inside the feeding device (1) by a nitrogen cylinder and then injecting the fluid for treatment into the feeding chamber (4-1) through the membrane assembly water inlet (4-9), starting a peristaltic pump so that the fluid for treatment passes through the reflux fluid outlet (4-12) through the connecting pipe to flow back to the feeding device (1); the fluid for treatment passing through the anode conductive membrane (4-4) for electro-oxidation filtration and entering the reaction chamber (4-2), and then passing through the three-dimensional carbon particles electrode (4-6) for adsorption and electrocatalysis; then, carrying out the electro-reduction filtration through the cathode conductive membrane (4-5), and the treated permeate flowing out through the membrane assembly outlet (4-10), thereby degradation of organic pollutants in the fluid for treatment is completed.

15. An operation method of said membrane-mediated electro-oxidation-reduction deep water treatment device according to claim 3, characterized in that, connecting the anode conductive membrane (4-4) to the positive electrode of the external power supply (5) through the conductive connector (4-11), connecting the cathode conductive membrane (4-5) to the negative electrode of the external power supply (5) through the conductive connector (4-11); pressurizing a fluid for treatment received inside the feeding device (1) by a nitrogen cylinder and then injecting the fluid for treatment into the feeding chamber (4-1) through the membrane assembly water inlet (4-9), starting a peristaltic pump so that the fluid for treatment passes through the reflux fluid outlet (4-12) through the connecting pipe to flow back to the feeding device (1); the fluid for treatment passing through the anode conductive membrane (4-4) for electro-oxidation filtration and entering the reaction chamber (4-2), and then passing through the three-dimensional carbon particles electrode (4-6) for adsorption and electrocatalysis; then, carrying out the electro-reduction filtration through the cathode conductive membrane (4-5), and the treated permeate flowing out through the membrane assembly outlet (4-10), thereby degradation of organic pollutants in the fluid for treatment is completed.

16. An operation method of said membrane-mediated electro-oxidation-reduction deep water treatment device according to claim 11, characterized in that,
connecting the anode conductive membrane (4-4) to the positive electrode of the external power supply (5) through the conductive connector (4-11), connecting the cathode conductive membrane (4-5) to the negative electrode of the external power supply (5) through the conductive connector (4-11); pressurizing a fluid for treatment received inside the feeding device (1) by a nitrogen cylinder and then injecting the fluid for treatment into the feeding chamber (4-1) through the membrane assembly water inlet (4-9), starting a peristaltic pump so that the fluid for treatment passes through the reflux fluid outlet (4-12) through the connecting pipe to flow back to the feeding device (1); the fluid for treatment passing through the anode conductive membrane (4-4) for electro-oxidation filtration and entering the reaction chamber (4-2), and then passing through the three-dimensional carbon particles electrode (4-6) for adsorption and electrocatalysis; then, carrying out the electro-reduction filtration through the cathode conductive membrane (4-5), and the treated permeate flowing out through the membrane assembly outlet (4-10), thereby degradation of organic pollutants in the fluid for treatment is completed.

17. An operation method of said membrane-mediated electro-oxidation-reduction deep water treatment device according to claim 12, characterized in that,
connecting the anode conductive membrane (4-4) to the positive electrode of the external power supply (5) through the conductive connector (4-11), connecting the cathode conductive membrane (4-5) to the negative electrode of the external power supply (5) through the conductive connector (4-11); pressurizing a fluid for treatment received inside the feeding device (1) by a nitrogen cylinder and then injecting the fluid for treatment into the feeding chamber (4-1) through the membrane assembly water inlet (4-9), starting a peristaltic pump so that the fluid for treatment passes through the reflux fluid outlet (4-12) through the connecting pipe to flow back to the feeding device (1); the fluid for treatment passing through the anode conductive membrane (4-4) for electro-oxidation filtration and entering the reaction chamber (4-2), and then passing through the three-dimensional carbon particles electrode (4-6) for adsorption and electrocatalysis; then, carrying out the electro-reduction filtration through the cathode conductive membrane (4-5), and the treated permeate flowing out through the membrane assembly outlet (4-10), thereby degradation of organic pollutants in the fluid for treatment is completed.

18. An operation method of said membrane-mediated electro-oxidation-reduction deep water treatment device according to claim 13, characterized in that,
connecting the anode conductive membrane (4-4) to the positive electrode of the external power supply (5) through the conductive connector (4-11), connecting the cathode conductive membrane (4-5) to the negative electrode of the external power supply (5) through the conductive connector (4-11); pressurizing a fluid for treatment received inside the feeding device (1) by a nitrogen cylinder and then injecting the fluid for treatment into the feeding chamber (4-1) through the membrane assembly water inlet (4-9), starting a peristaltic pump so that the fluid for treatment passes through the reflux fluid outlet (4-12) through the connecting pipe to flow back to the feeding device (1); the fluid for treatment passing through the anode conductive membrane (4-4) for electro-oxidation filtration and entering the reaction chamber (4-2), and then passing through the three-dimensional carbon particles electrode (4-6) for adsorption and electrocatalysis; then, carrying out the electro-reduction filtration through the cathode conductive membrane (4-5), and the treated permeate flowing out through the membrane assembly outlet (4-10), thereby degradation of organic pollutants in the fluid for treatment is completed.

19. The membrane-mediated electro-oxidation-reduction deep water treatment device according to claim 16, characterized in that, the organic pollutants comprises aldrin, chlordane, dieldrin, endrin, heptachlor, hexabromobiphenyl, mirex, toxaphene, polychlorinated biphenyls, DDT, polychlorinated dibenzo-p-dioxins, polychlorinated dibenzofurans, alpha-hexachlorocyclohexane, beta-hexachlorocyclohexane, lindane, chlordecone, pentachlorobenzene, pentachlorophenol and its salts and esters, hexachlorobutadiene, polychlorinated naphthalene, short-chain chlorinated paraffins, dicofol, technical-grade endosulfan isomers, hexabromocyclododecane, tetrabromodiphenyl ether, pentabromodiphenyl ether, hexabromodiphenyl ether, heptabromodiphenyl ether, decabromodiphenyl ether and perfluorooctanoic acid and its salts.

20. The membrane-mediated electro-oxidation-reduction deep water treatment device according to claim 16, characterized in that, the organic pollutants comprises aldrin, chlordane, dieldrin, endrin, heptachlor, hexabromobiphenyl, mirex, toxaphene, polychlorinated biphenyls, DDT, polychlorinated dibenzo-p-dioxins, polychlorinated dibenzofurans, alpha-hexachlorocyclohexane, beta-hexachlorocyclohexane, lindane, chlordecone, pentachlorobenzene, pentachlorophenol and its salts and esters, hexachlorobutadiene, polychlorinated naphthalene, short-chain chlorinated paraffins, dicofol, technical-grade endosulfan and its isomers, hexabromocyclododecane, tetrabromodiphenyl ether, pentabromodiphenyl ether, hexabromodiphenyl ether, heptabromodiphenyl ether, decabromodiphenyl ether and perfluorooctanoic acid and its salts.
